(19) United States
(12) Patent Application Publication
(10) Pub. No.: US 2008/0129007 A1
(43) Pub. Date: Jun. 5, 2008

(54) Rowing Bike

(76) Inventor: Gil Sung Lee, Gyeonggi-Do (KR)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/569,224

(22) PCT Filed: May 20, 2005
(86) PCT No.: PCT/KR05/01480

§ 371 Date: Nov. 16, 2006

(30) Foreign Application Priority Data
May 21, 2004 (KR) 10-2004-0036224
May 18, 2005 (KR) 10-2005-0041443

(51) Int. Cl. B62M 1/14; B62M 3/14

(52) U.S. Cl. 280/242.1

(57) ABSTRACT

A rowing bike operated in a manner similar to a rowing boat. The rowing bike includes a body frame, a handle part having both a front wheel and a foothold, and rear wheels provided at the back of the body frame. The body frame has two parallel guide rods oriented in a longitudinal direction. The rowing bike further includes two drive levers, one provided on each side of the body frame, so that, when the drive levers are repeatedly levered upwards, the driving force of the drive levers is transmitted to the rear wheels. The rowing bike further includes a seat movable along the guide rods. A rack having a spur gear is mounted to the seat. Thus, when the seat is linearly reciprocated forwards and backwards, the driving force of the seat is transmitted to the rear wheels through a gear mechanism engaging with the rack gear.

### DESCRIPTION OF DRAWINGS

FIG. 1 is a perspective view illustrating a rowing bike according to the present invention;

FIG. 2 is an exploded perspective view illustrating the construction of the rowing bike according to the present invention;

FIG. 3 is a perspective view illustrating the engagement of a rack and two ratchet wheels according to the present invention;

FIG. 4 is a perspective view illustrating another embodiment of the present invention; and

FIG. 5 is a perspective view illustrating a further embodiment of the present invention.

### DESCRIPTION OF REFERENCE CHARACTERS OF IMPORTANT PARTS

| | |
|---|---|
| 10: | row bike |
| 12: | front wheel |
| 14: | foothold |
| 16: | handle part |
| 18: | parallel bars |
| 20: | body frame |
| 23, 24: | transverse beams |
| 25, 26: | guide rods |
| 27, 28: | springs |
| 31: | rear wheel axle |
| 32: | gear |
| 33: | front drive gear |
| 34: | front ratchet wheel |
| 35: | gear shaft |
| 36: | ratchet sprocket |
| 37: | wheel |
| 40: | seat |
| 42: | drive lever |
| 43: | chain |
| 44: | spring |
| 45, 46: | sliding blocks |
| 47: | rack |
| 48: | spur gear |
| 50: | rail |
| 52: | rear wheel |
| 53: | rear drive gear |
| 54: | rear ratchet wheel |
| 55: | rear shaft |
| 63: | transmission gear |
| 65: | transmission shaft |
| 72: | hanger |
| 74: | ratchet gear |
| 78: | hinge |
| 94: | foothold |

### DISCLOSURE

### Technical Field and Background Art

The present invention relates, in general, to wheeled land rowing vehicles and, more particularly, to a rowing bike which allows a user to produce a driving force by levering handles upwards as though the user were rowing a rowing machine, and to steer the rowing bike and to produce a driving force by repeatedly moving his/her body backwards using the power of his/her legs while sitting on a seat 40 and placing his/her feet in respective footholds 14, thus transmitting a driving force several times as high as the force transmitted to a rear wheel when the user rides a conventional bike.

Rowing is a boat racing contest between several teams to row respective boats on water, thus moving the boats forwards and determining the ranking. Therefore, rowing requires the players of each team to row a boat in strict and synchronous order. Therefore, a conventional rowing boat cannot be appropriately moved by a single person at a desired speed. Furthermore, the conventional rowing boat cannot be used on the ground. A bike is a wheeled vehicle that is held by the hands of a rider and transmits the power of the rider, who continuously pedals with his/her feet, to a rear wheel, thus being moved forwards and allowing the rider to exercise to increase the strength of the leg muscles and slightly increase the strength of the abdominal muscles. However, the bike riding limitedly increases the muscular strength of riders. Furthermore, a conventional rowing machine has been proposed and used. However, the conventional rowing machine is a fixed exercise machine that only allows a user to go through the motions of rowing in a fixed place, so that many users are liable to lose interest in the conventional rowing machines.

In recent years, leg exercise machines, realized to be operated by the leg power of users, have been proposed and used. These leg exercise machines provide only limited exercise effects. In the prior art, no exercise machine, which is operated using the muscular power of all of the parts of a user's body, has been proposed.

Therefore, it has been required to propose an exercise machine which allows a user to exercise in order to increase the muscular strength of all parts of the body, for example, the abdominal muscular strength and the arm muscular strength, while the user enjoys fast motion as expected from riding a bike.

### DISCLOSURE

### Technical Problem

Accordingly, the present invention has been made keeping in mind the above problems occurring in the prior art, and an object of the present invention is to provide a rowing bike which allows a user to produce a driving force by levering handles upwards as though the user were rowing a rowing machine, and to steer the rowing bike and to produce a driving force by repeatedly moving his/her body backwards and forwards using the power of his/her legs while sitting on a seat 40 and placing his/her feet in respective footholds 14.

### MODE FOR INVENTION

The present invention relates to wheeled land rowing vehicles and, more particularly, to a rowing bike which allows a user to produce a driving force by levering handles upwards as though the user were rowing a rowing machine, and to steer the rowing bike and to produce a driving force by repeatedly moving his/her body forwards and backwards using the power of his/her legs while sitting on a seat 40 and placing his/her feet in respective footholds 14, thus transmitting driving force several times as high as the force transmitted to a rear wheel while the user rides a conventional bike.

The present invention provides a rowing bike having wheels, which is constructed such that a user, sitting on a seat 40 and placing his/her feet in respective footholds 14, produces a driving force by pulling drive levers 42 as though the user were rowing a rowing boat, and steers the rowing bike and transmits the driving force to a rear wheel axle 31 by reciprocating the seat 40 using leg power.

In the rowing bike, a body frame 20 of the rowing bike 10 may comprise: parallel bars 18; transverse beams 23, 24 transversely mounted to front and rear parts of the parallel bars 18, respectively; parallel guide rods 25, 26 mounted to the transverse beams 23, 24 and extending in longitudinal directions; and a seat 40 mounted to the guide rods 25, 26 such that the seat is slidable in the longitudinal direction.

The seat 40 may comprise: sliding blocks 45, 46 mounted to a lower part of the seat and guided by the guide rods 25, 26; and a rack 47 mounted to the lower part of the seat 40 with a spur gear 48 formed along a lower surface of the rack 47, the spur gear 48 of the rack engaging with both a front ratchet wheel 34 of a gear shaft 35 and a rear ratchet wheel 54 of a rear shaft 55 at the same time.

The gear shaft 35 may comprise a front drive gear 33 which engages with a gear 32 mounted to the rear wheel axle 31, and the rear shaft 55 may comprise a rear drive gear 53 which engages with a transmission gear 63 mounted to a transmission shaft 65, wherein the transmission gear 63 engages with the gear 32 mounted to the rear wheel axle 31.

Each of the guide rods 25, 26 may be provided at front and rear ends thereof with springs 27, 28, respectively.

At least one rear wheel 52 may be mounted to each end of the rear wheel axle 31 which is supported by the transverse beam 24 using a bearing, with the gear 32 mounted to the center of the rear wheel axle 31.

The front drive gear 33, the transmission gear 63 and the rear drive gear 53 may comprise ratchet gears which transmit the driving force in one direction, thus preventing the driving force from being consumed by friction, and either the front drive gear 33 or the rear drive gear 53 may be fixed so as to prevent the rowing bike from moving backwards.

The drive levers 42 may be coupled to respective hinges 50 provided on the parallel bars 18, thus being rotated around the hinges 50, and may be coupled to respective chains 43 at ends thereof, each of the chains 43 being coupled to a spring 44 which provides a restoring force to the chain, the spring 44 being fastened to the transverse beam 23, and the chain 43 being wrapped around a ratchet sprocket 36 and transmitting the driving force to the gear shaft 35.

Each of the drive levers 42 is coupled by a hinge to the transverse beam 24 at an end thereof, and a ratchet gear 74 is provided at each end of the gear shaft 35 and engages with an arc-shaped gear 76 mounted to each of the drive levers 42.

Described again in brief, the rowing bike according to the present invention comprises a handle part 16 having a front wheel 12 provided with steering footholds 14; a body frame 20, and rear wheels 52 mounted to the parallel bars 18 at predetermined positions in the back of the body frame 20. The body frame 20 comprises parallel bars 18; transverse beams 23, 24 transversely mounted to front and rear parts of the parallel bars 18, respectively; and parallel guide rods 25, 26 mounted to the transverse beams 23, 24 and extending in longitudinal directions, wherein a rowing exercise unit is provided at opposite sides of the body frame 20. The seat 40 may have sliding blocks 45, 46 which are mounted to the lower surface of the seat 40 and are guided by the guide rods 25, 26, with a rack 47 mounted to the rear part of the lower surface of the seat 40 and having a spur gear 48 formed along the lower surface of the rack 47. The spur gear 48 of the rack 47 engages with both a front ratchet wheel 34 of a gear shaft 35 and a rear ratchet wheel 54 of a rear shaft 55, thus transmitting power to the gear 32 of the rear wheel axle 31. In a similar manner, a rear shaft 55, a rear ratchet wheel 54, a rear drive gear 53, a transmission gear 63 and a transmission shaft 65 are provided behind the rear wheel axle 31, so that, when the seat 40 is moved forwards and backwards, the driving force can be transmitted to the rear wheel axle 31. Furthermore, a user may lever the drive levers 42 upwards while holding the levers 42 with his/her hands, thus transmitting a driving force to the rear wheel axle 31 by way of the springs 44, the chains 43 and the ratchet sprockets 36.

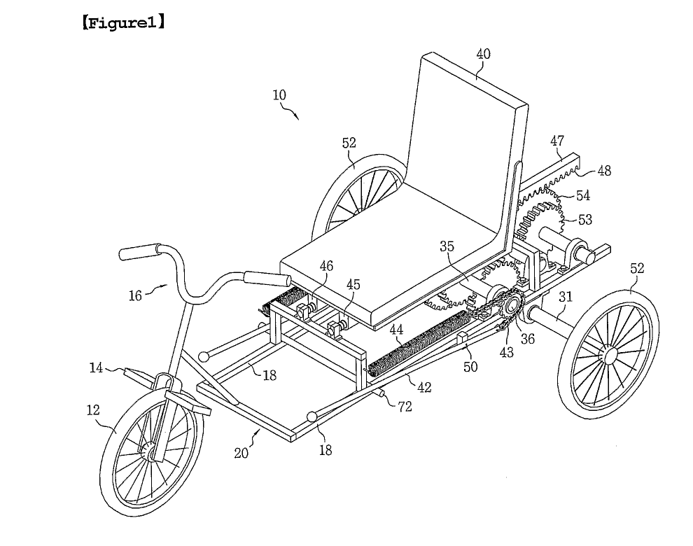

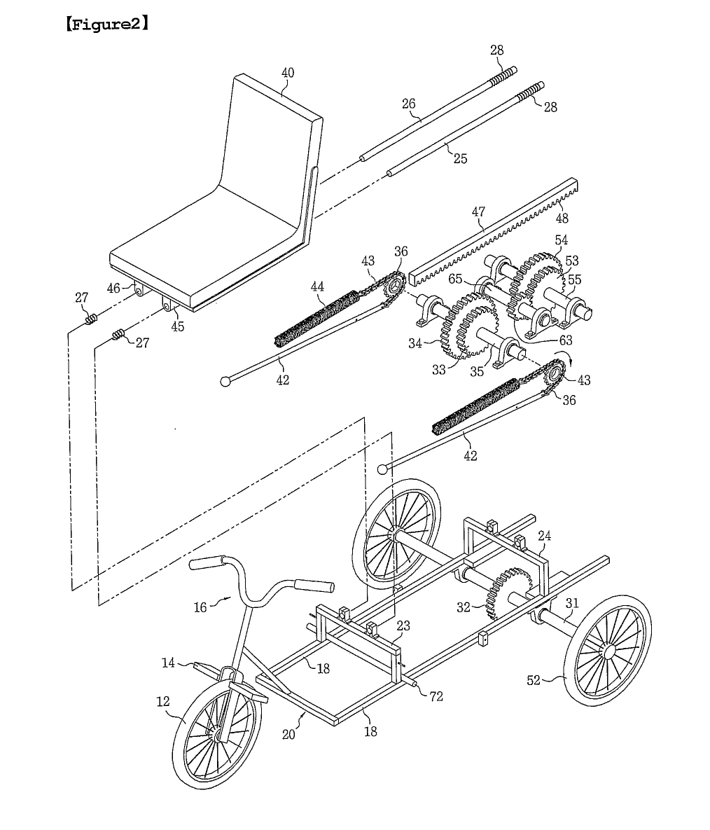

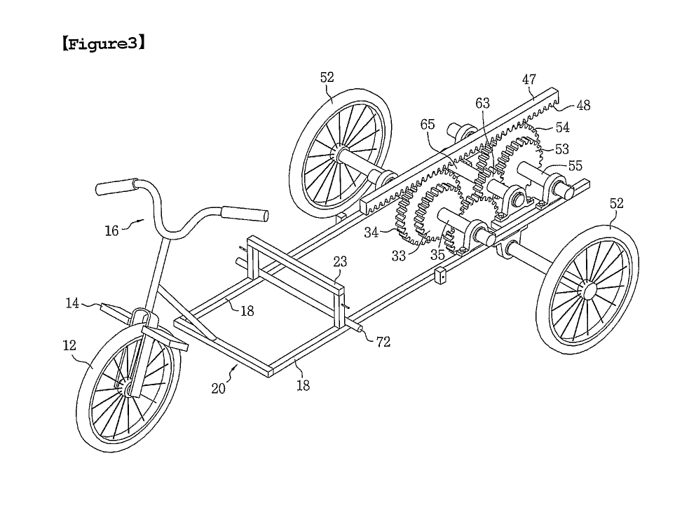

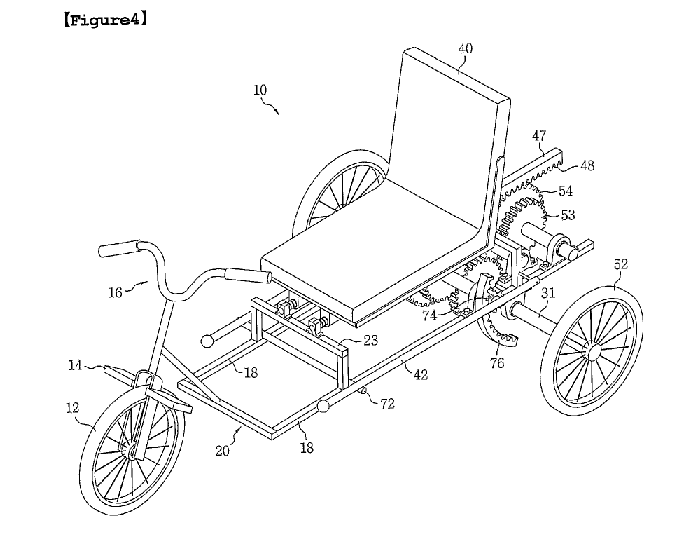

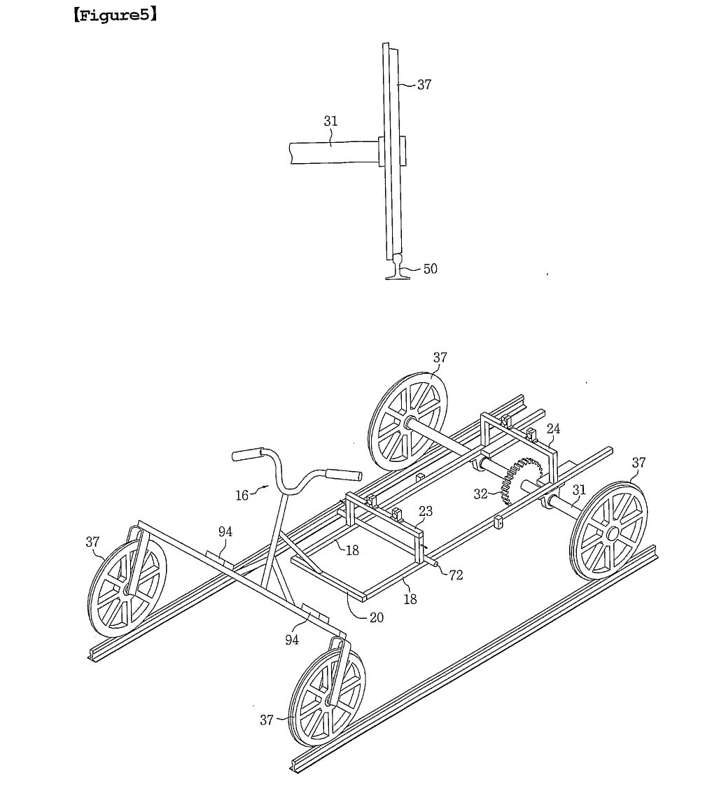

The following description to describe the present invention will be taken in conjunction with the accompanying drawings, in which FIG. 1 is a perspective view illustrating a rowing bike according to the present invention; FIG. 2 is an exploded perspective view illustrating the construction of the rowing bike according to the present invention; FIG. 3 is a perspective view illustrating the engagement of a rack and two ratchet wheels according to the present invention; FIG. 4 is a perspective view illustrating another embodiment of the present invention; and FIG. 5 is a perspective view illustrating a further embodiment of the present invention.

Hereinbelow, preferred embodiments of the present invention will be described in detail with reference to the accompanying drawings.

FIG. 1 is a perspective view illustrating the rowing bike according to the present invention. As shown in the drawing, the rowing bike is constructed to allow a user to produce a driving force by levering handles (drive levers 42) upwards as though the user were rowing a rowing machine, and to steer the rowing bike and produce a driving force by moving his/her body backwards and forwards using the power of his/her legs while sitting on a seat 40 and placing the feet in respective footholds 14, thus transmitting a driving force several times as high as the force transmitted to a rear wheel while the user rides a conventional bike.

The rowing bike according to the present invention includes a handle part 16 which is provided at the front part of the rowing bike and has a front wheel 12. The rowing bike further includes a body frame 20 and two rear wheels 52 which are provided at the rear part of the body frame 20.

The body frame 20 comprises two parallel bars 18 and two transverse beams 23 and 24 transversely mounted to the front and rear parts of the two parallel bars 18.

Two parallel guide rods 25 and 26 are mounted to the transverse beams 23 and 24 such that the parallel guide rods 25 and 26 extend in longitudinal directions, with a seat 40 mounted to the guide rods 25 and 26 such that the seat 40 is rectilinearly slidable along the guide rods 25 and 26 in the longitudinal direction.

Furthermore, a rowing exercise unit is provided at opposite sides of the body frame.

The rowing exercise unit comprises two drive levers 42 which are rotatably mounted by respective hinges 50 to the parallel bars 18 of the body frame 20. The drive levers 42 are also coupled to respective chains 43 at ends thereof, while each of the chains 43 are coupled to a spring 44 which provides a restoring force to the chain 43. The spring 44 is fastened to the transverse beam 23.

The rowing bike further comprises a hanger 72, so that, when a user does not use the two drive levers 42 or uses only one lever 42, the unused lever(s) 42 may be placed over the hanger 72.

Rear wheels 52 are mounted to opposite ends of the rear wheel axle 31 which is supported by the transverse beam 24 or the parallel bars 18 using a bearing, with the gear 32 mounted to the center of the rear wheel axle 31.

In front of the rear wheel axle 31, a gear shaft 35 is placed. The gear shaft 35 comprises a front drive gear 33, which engages with the gear 32 of the axle 31, and a front ratchet wheel 34. The gear shaft 35 is supported by the body frame 20 through a bearing. In a similar manner, a rear shaft 55, a rear ratchet wheel 54, a rear drive gear 53, a transmission gear 63 and a transmission shaft 65 are provided in back of the rear wheel axle 31. Therefore, when the seat 40 is moved forwards and backwards, the rowing bike transmits the driving force to the rear wheel axle 31.

Two ratchet sprockets 36 are mounted to opposite ends of the gear shaft 35 with the chains 43 wrapped around respective ratchet sprockets 36. When the ratchet sprockets 36 are rotated clockwise, the sprockets can transmit power. However, when the sprockets 36 are rotated counterclockwise, they idle-rotate to transmit no power.

The handle part 16, which comprises a front wheel 12 and footholds 14 so that the handle part 16 may be steered by the feet of a user, is provided at the front part of the body frame. The handle part 16 has a brake (not shown) which is hand-operated in a manner similar to the hand brake of a conventional bicycle, thus being used when it is required to reduce the speed, for example, in the case of emergencies. The user may steer the rowing bike by pushing the footholds 14 to the left or right with his/her feet or by manipulating the handle part 16 with his/her hands.

FIG. 2 is an exploded perspective view illustrating the construction of the rowing bike according to the present invention. Hereinbelow, the rowing bike will be described in detail with reference to FIGS. 2 and 3. The seat 40 comprises sliding blocks 45, 46 which are mounted to the lower surface of the seat and are guided by the guide rods 25, 26. A rack 47 is mounted to the lower surface of the seat 40, with a spur gear 48 formed along the lower surface of the rack 47. The spur gear 48 of the rack 47 engages with both the front ratchet wheel 34 of the gear shaft 35 and the rear ratchet wheel 54 of the rear shaft 55 at the same time.

The rear drive gear 53, which is placed adjacent to the rear ratchet wheel 54, engages with the transmission gear 63. The transmission gear 63 engages with the gear 32 of the rear wheel axle, thus transmitting the power to the rear wheels.

When the rack 47 moves rearwards, the front ratchet wheel 34 is rotated clockwise and transmits a rotating force. However, when the rack 47 moves forwards, the front ratchet wheel 34 is idle-rotated counterclockwise and cannot transmit a rotating force. Furthermore, when the rack 47 moves forwards, the rear ratchet wheel 54 is rotated counterclockwise and transmits a rotating force. However, when the rack 47 moves rearwards, the rear ratchet wheel 54 is idle-rotated clockwise and cannot transmit a rotating force.

Each of the guide rods 25, 26 is provided at front and rear ends thereof with springs 27, 28, respectively, thus reducing impact generated when the seat 40 collides with front and rear fixtures of the guide rods 25 and 26, and allowing the seat 40 to have a resilient structure. Furthermore, the two footholds 14 are provided at opposite sides of the front wheel 12, so that a user can push his/her body backwards while placing his/her feet in the footholds 14.

The rowing bike having the above-mentioned construction will be described hereinbelow.

First, to ride the rowing bike while levering the drive levers 42, a user operates the rowing bike as follows.

The user sits on the seat 40, places his/her feet in the two footholds 14 of the front wheel 12, and steers the rowing bike.

Furthermore, the user holds the two drive levers 42 with his/her hands and levers the drive levers 42 upwards.

Thus, the chains 43, which are coupled to the two drive levers 42, rotate the ratchet sprockets 36 clockwise, thus transmitting a rotating force to the front drive gear 33 through the gear shaft 35.

The front drive gear 33 rotates the gear 32 of the rear wheel axle 31 counterclockwise, so that the rear wheels 52 are rotated forwards.

When the user rotates the drive levers 42 counterclockwise, the chains 43 are moved by the elastic force of the springs 44, so that the ratchet sprockets 36 are rotated counterclockwise. However, the sprockets 36 do not transmit any rotational force to the gear shaft 35.

Therefore, the drive levers 42 transmit the rotating force to the rear wheels only when the levers 42 are levered upwards (or rotated clockwise), so that the drive levers may be levered as though the user were rowing a rowing boat.

Second, to ride the rowing bike while moving the sear 40 forwards and backwards, the user operates the rowing bike as follows.

The user, sitting on the seat, holds the handle 10 with his/her hands and places his/her feet in the footholds 14, and, thereafter, stretches his/her legs, thus pushing the seat 40 backwards. In the above state, the rack 47 of the seat 40 is moved backwards, so that the front ratchet wheel 34 is rotated clockwise. Therefore, the front drive gear 33, which is mounted to both the front ratchet wheel 34 and the front gear shaft 35, is rotated clockwise, so that the gear 32, which is mounted to the rear wheel axle 31 and engages with the front drive gear 33, is rotated counterclockwise, thereby transmitting the driving force to the rear wheel axle 31. Thus, the rear wheels 52, which are mounted to the rear wheel axle 31, are rotated counterclockwise and move the rowing bike forwards.

Thereafter, the user pulls the seat 40 forwards by bending his/her knees. In the above state, the rack 47 of the seat 40 is moved forwards, so that the rear ratchet wheel 54 is rotated counterclockwise. Therefore, the front drive gear 53, which is mounted to both the rear ratchet wheel 54 and the rear gear shaft 55, is rotated counterclockwise, so that the transmission gear 63, which is mounted to the transmission 65 and engages with the rear drive gear 53, is rotated clockwise. Therefore, the gear 32, which is mounted to the rear wheel axle 31 and engages with the transmission gear 63, is rotated counterclockwise, thereby transmitting the driving force to the rear wheel axle 31. Thus, the rear wheels 52, which are mounted to the rear wheel axle 31, are rotated counterclockwise and move the rowing bike forwards.

More preferably, the front drive gear 33 is configured to transmit the driving force when the rack 47 is moved backwards. Thus, the front drive gear 33 transmits the driving force during clockwise rotation, but idle-rotates during counterclockwise rotation, thus friction is prevented from consuming driving force. Furthermore, the front drive gear 53 is configured to transmit the driving force when the rack 47 is moved forwards. The rear drive gear 53 transmits the driving force during counterclockwise rotation, but idle-rotates during clockwise rotation, thus friction is prevented from consuming driving force.

It is preferred to prevent the rowing bike from moving backwards while the bike travels up a hill. However, when the front drive gear 33, the transmission gear 63 and the rear drive gear 53 are configured as ratchet gears, it is almost impossible to prevent the rowing bike from moving backwards. Thus, to prevent the rowing bike from moving backwards, either the front drive gear 33 or the rear drive gear 53 is fixed.

In the above description, the user may lever the drive levers 42 upwards using the power of his/her arms, thus moving the rowing bike forwards. Alternatively, the user may move the seat 40 forwards and backwards using the power of his/her legs, thus moving the rowing bike forwards. However, it should be understood that the user may move the rowing bike forwards using the power of both the arms and the legs while the user steers the rowing bike using his/her feet placed in the footholds. Thus, the user may exercise using the rowing bike to increase the muscular strength of all parts of his/her body.

FIG. 3 is a perspective view illustrating in detail the engagement of the rack 47, front ratchet wheel 34, rear ratchet wheel 54, transmission gear 63, front drive gear 33, rear drive gear 53, and gear 32.

This drawing illustrates the construction to transmit the driving force to the rear wheels 52 when the seat 40 moves forwards and backwards. To increase the rotating speed of the wheels relative to the forward and backward moving speed of the seat 40, the diameters of both the front drive gear 33 and the rear drive gear 53 relative to the gear 32 are controlled. Described in detail, when the diameters of both the front and rear drive gears 33, 53 are larger than the diameter of the gear 32, the rotating speed of the wheels is increased. However, the diameter the gear 32 is larger than the diameters of both the front and rear drive gears 33, 53, the rotating speed of the wheels is reduced. Therefore, it is possible to select a desired moving speed of the rowing bike by changing the diameters of the gears to correspond to the physique and power of a user. Furthermore, it is also possible to increase the rotating speed of the wheels by reducing the diameters of both the front ratchet wheel 34 and the rear ratchet wheels 54 which engage with the rack 47. Therefore, a first stage speed change mode may be selected. Furthermore, a second stage speed change mode may be selected by appropriately selecting the diameters of the gear 32, the front drive gear 33 and the rear drive gear 53.

When two rear wheels 52 are mounted to opposite ends of the rear wheel axle 31, the rowing bike may not easily or safely move along a curve. Thus, to reduce the radius of curvature of the rowing bike, only one rear wheel 52 may be mounted to the rear wheel axle 31. Furthermore, a differential gear mechanism or a planetary gear mechanism which is a gear transmission mechanism may be adapted to the rowing bike of the present invention in an effort to provide smooth rotation of the wheels.

FIG. 4 is a perspective view illustrating another embodiment of the present invention, which is configured such that a user moves the rowing bike forwards by levering the drive levers 42 upwards using the power of his/her arms.

Described in detail, each of the drive levers 42 is coupled by a hinge 78 to the transverse beam 24 at an end thereof, thus being rotated around the hinge 78. Furthermore, a ratchet gear 74 is provided at each end of the gear shaft 35 and engages with an arc-shaped gear 76 mounted to a side of each of the drive levers 42.

When a user levers the drive levers 42 upwards while holding the levers 42 with his/her hands, the arc-shaped gears 76 are rotated counterclockwise, while the ratchet gears 76, which engage with the arc-shaped gears 76, are rotated clockwise, thus rotating the gear shaft 35 clockwise and transmitting a driving force to the rear wheels. In the above state, a counterclockwise rotating force is transmitted to the gear 32 which engages with the front drive gear 33 of the gear shaft 35. When the diameters of the ratchet gears 74 are smaller than the moving angles of the arc-shaped gears 76, a rotating force having high angular velocity may be transmitted to the gear shaft 35. Thus, a desired moving velocity of the rowing bike may be selected by reducing or increasing the diameters of the ratchet gears 74.

FIG. 5 is a perspective view illustrating a further embodiment of the present invention, which is configured to allow a user to ride the rowing bike on rails while exercising using the bike to increase the muscular strength of all parts of his/her body. Described in detail, two wheels 37, in place of the single front wheel 12 of the above-mentioned embodiment, are rotatably mounted to opposite sides of the handle part 16. Furthermore, two wheels 37, having a structure similar to a conventional railroad flywheel and substituting for the two rear wheels 52 of the above-mentioned embodiment, are rotatably mounted to opposite ends of the rear wheel axle 31.

This rowing bike is constructed such that the four wheels 37, which substitute for the front and rear wheels of the above-mentioned embodiment, move along rails 50. Thus, the rowing bike enjoys relatively reduced friction and does not require a user to steer the bike with his/her feet placed in the footholds 94. Therefore, the user can drive the rowing bike using the power of all parts of his/her body and can propel the rowing bike at an increased speed.

Furthermore, while the wheels of the rowing bike move along the rails 50, the rowing bike can automatically change its moving direction. Furthermore, the rowing bike is not likely to be overturned or derailed due to its structural stability, so that the rowing bike secures operational safety.

Although the preferred embodiments of the present invention have been disclosed in conjunction with the accompanying drawings for illustrative purposes, those skilled in the art will appreciate that the present invention is not limited to the embodiments, but various modifications, additions and substitutions are possible, without departing from the scope and spirit of the invention.

### INDUSTRIAL APPLICABILITY

As described above, the rowing bike according to the present invention is constructed such that a user can repeatedly pull a handle as though he/she were rowing a rowing boat and can move his/her body backwards, thus transmitting a quantity of motion and obtaining a desired physical effect obtained from rowing. Thus, the present invention provides a highly efficient rowing bike which allows a user to efficiently exercise to increase the strength of the muscles of all parts of his/her body, such as the leg muscles, arm muscles and abdominal muscles, while enjoying fast motion as expected from riding a bike.

1: A rowing bike having wheels, which is constructed such that a user, sitting on a seat and placing his/her feet in respective footholds, produces a driving force by pulling drive levers as though the user were rowing a rowing boat, and steers the rowing bike and transmits the driving force to a rear wheel axle by reciprocating the seat using leg power.

2: The rowing bike according to claim 1, wherein a body frame of the rowing bike comprises: parallel bars; transverse beams transversely mounted to front and rear parts of the parallel bars, respectively; parallel guide rods mounted to the transverse beams and extending in longitudinal directions; and a seat mounted to the guide rods such that the seat is slidable in the longitudinal direction.

3: The rowing bike according to claim 2, wherein the seat comprises: sliding blocks mounted to a lower part of the seat and guided by the guide rods; and a rack mounted to the lower part of the seat with a spur gear formed along a lower surface of the rack, the spur gear of the rack engaging with both a front ratchet wheel of a gear shaft and a rear ratchet wheel of a rear shaft at the same time.

4: The rowing bike according to claim 3, wherein the gear shaft comprises a front drive gear which engages with a gear mounted to the rear wheel axle, and the rear shaft comprises a rear drive gear which engages with a transmission gear mounted to a transmission shaft, wherein the transmission gear engages with the gear mounted to the rear wheel axle.

5: The rowing bike according to claim 4, wherein each of the guide rods is provided at front and rear ends thereof with springs, respectively.

6: The rowing bike according to claim 5, wherein at least one rear wheel is mounted to each end of the rear wheel axle which is supported by the transverse beam using a bearing, with the gear mounted to a center of the rear wheel axle.

7: The rowing bike according to claim 6, wherein a pair of wheels is coupled to the rear wheel axle, a pair of wheels is coupled to a rotatable handle part, and rails are provided to allow the wheels to move along the rails.

8: The rowing bike according to claim 7, wherein the front drive gear, the transmission gear and the rear drive gear comprise ratchet gears which transmit the driving force in one direction, thus preventing the driving force from being consumed by friction, and either the front drive gear or the rear drive gear is fixed so as to prevent the rowing bike from moving backwards.

9: The rowing bike according to claim 1, wherein the drive levers are coupled to respective hinges provided on the parallel bars, thus being rotated around the hinges, and are coupled to respective chains at ends thereof, each of the chains being coupled to a spring which provides a restoring force to the chain, the spring being fastened to the transverse beam, and the chain being wrapped around a ratchet sprocket and transmitting the driving force to the gear shaft.

10: The rowing bike according to claim 1, wherein each of the drive levers is coupled by a hinge to the transverse beam at an end thereof, and a ratchet gear is provided at each end of the gear shaft and engages with an arc-shaped gear mounted to each of the drive levers.
